(19) United States
(12) Patent Application Publication
(10) Pub. No.: US 2025/0275019 A1
(43) Pub. Date: Aug. 28, 2025

(54) Transparent Flexible Foil Heater

(71) Applicant: Chasm Advanced Materials, Inc., Canton, MA (US)

(72) Inventors: Daniel T. Skiba, Milton, MA (US); Sean P. Arthur, Walpole, MA (US); David J. Arthur, Braintree, MA (US); Robert F. Praino, Jr., Westwood, MA (US)

(73) Assignee: Chasm Advanced Materials, Inc., Canton, MA (US)

(21) Appl. No.: 19/196,375

(22) Filed: May 1, 2025

Related U.S. Application Data
(63) Continuation of application No. PCT/US2024/013454, filed on Jan. 30, 2024.
(60) Provisional application No. 63/442,644, filed on Feb. 1, 2023.

(51) Int. Cl. H05B 3/86; G01S 7/40; G02B 7/02

(52) U.S. Cl. CPC H05B 3/86; G01S 7/4047; G02B 7/028; H05B 2203/014; H05B 2203/016; H05B 2203/017; H05B 2214/02; H05B 2214/04

(57) ABSTRACT

A transparent flexible foil heater element with a clear plastic film with a surface, and a metal mesh on the surface of the film, the metal mesh comprising intersecting spaced metal traces that have a line width, wherein a spacing between adjacent traces defines a mesh pitch, the mesh defines an open area within the mesh that exposes the film surface, and the mesh has a sheet resistance. The metal mesh line width is less than 9 microns, the mesh pitch is at least 1 mm, the open area is at least 95%, and the sheet resistance is less than 30 ohms per square.

### CROSS-REFERENCE TO RELATED APPLICATIONS

This application claims priority of PCT/US2024/013454, filed on Jan. 30, 2024, which itself claimed priority of Provisional Patent application 63/442,644, filed on Feb. 1, 2023. The entire disclosures of both priority applications are incorporated herein by reference and for all purposes.

### BACKGROUND

This disclosure relates to a transparent flexible foil heater that can be used to deice or defog a lens.

Since the adoption of LED lighting for automotive headlights, it is well known that LEDs do not generate enough heat to prevent the headlight lenses from getting covered with ice or snow or frost during inclement weather. Thus, it is desired to integrate a transparent heater foil into the headlight lens assembly for deicing or defogging, where the transparent heater foil also has high visible light transparency, low haze and neutral color to not detract from the lighting system function and not compromise too much the aesthetics of the vehicle. It is further desired that the transparent heater foil be capable of accommodating 3D shapes (typically via vacuum or pressure thermoforming), to match the shape of the lens; and capable of being attached to the lens via optically clear adhesive (OCA) or more preferably via film insert molding (where the lens is injection molded from clear plastic resin while the transparent heater foil is inserted into the mold tool).

In recent years, there has been increasing use of various sensors that are critical to Advanced Driver Assistance Systems (“ADAS”). These sensors include optical camera sensors, light detection and ranging (LiDAR) sensors, and radar sensors. In all cases these sensors use a lens of some sort that protects the sensor from the environment and can have other functions such as focusing electromagnetic radiation passing through the lens. The lens is typically molded plastic, but sometimes glass. In most cases these sensors do not function properly if the lens is covered with water droplets, fog, frost, snow or ice during inclement weather. Thus, the automotive safety systems become compromised. Eventually autonomous driving is expected to become very popular. However, this will not happen unless the ADAS sensors can be more reliable during inclement weather.

In some cases, there are ADAS sensors that are located behind headlight lenses. In these cases, the transparent heater foils for the headlight lens need to meet all of the visible light (wavelengths in the 400 to 700 nm range) transparency, low haze, neutral color and aesthetics requirements for the lighting system, while also meeting the transparency requirements of the ADAS sensor. If the ADAS sensor is LiDAR, then high transparency is also needed at the near infrared (NIR) wavelengths, more specifically at 905 nm and 1,550 nm (which are common wavelengths used today for LiDAR). If the ADAS sensor is radar, then high transparency (aka, low attenuation) is needed at wavelengths associated for the mm-wave electromagnetic waves used for ADAS. The most common radar frequency used today for ADAS is about 77 GHz, which has a free space wavelength of about 3.9 mm.

In many cases the ADAS sensors are located in the bumper areas or the grille areas or the window glass areas. In all cases it is desirable to integrate the transparent heater foil into the lenses that are located in these areas.

The leading transparent heater solution for radar sensors for ADAS is opaque microwires that are made from either printed or embedded metal wires, wherein the width of the microwires is typically less than 1 mm (i.e., micron-scale). Opaque microwires are much like what is seen when looking through a rear window defogger in an automobile. To achieve high radar transmission, the spacing between microwires is chosen to be large enough to create apertures that are about 5 mm (about meaning in this case perhaps +/−1 mm), which are sufficiently larger than the wavelength of incident radar signals (typically about 3.9 mm) to allow low radar attenuation (i.e., high radar transmission). With this geometry opaque microwires can still achieve high power densities at 12V (>1,000 W/m²) for rapid deicing (<10 minutes). However, once the lens surface is clear, the opaque microwires are readily visible to the unaided human eye, which is undesirable from an aesthetics standpoint for automotive applications.

The leading transparent heater solution for lighting systems (e.g., headlights) are opaque microwires. This solution provides adequate power density for rapid deicing (even at 12V) and reasonably high visible light transmission, but the microwires are clearly visible, which is highly undesirable for aesthetics.

### SUMMARY

Aspects and examples are directed to a transparent heater foil comprising a metal mesh layer with sufficiently low sheet resistance to deliver the required power density and sufficiently high transparency at the required wavelengths for the target transparent heater foil application.

All examples and features mentioned below can be combined in any technically possible way.

Featured in this disclosure is a transparent flexible foil heater element that has a clear plastic film with a surface, and a metal mesh on the surface of the film. The metal mesh comprises intersecting spaced metal traces. The inter-trace spacing can be regular, or not. The traces have a line width, a spacing between adjacent traces defines a mesh pitch, the mesh defines an open area within the mesh that exposes the film surface, and the mesh has a sheet resistance. In an example the line width is less than about 9 microns. In an example the mesh pitch is at least about 1 mm. In an example the open area is at least about 95%. In an example the sheet resistance is less than about 30 ohms per square (ops).

In an example the mesh pitch is at least about 3.9 mm. In an example the mesh pitch is at least about 5 mm. “About” in this instance can be interpreted as a typical manufacturing tolerance, which may be +/−1 mm.

In an example the clear plastic film comprises at least one of polyethylene terephthalate (PET), polycarbonate (PC) and cyclo-olefin polymer (COP). In an example the clear plastic film is about 100 microns thick. About can be interpreted as a typical manufacturing tolerance, which may be +/−5%. In this case that amounts to +/−5 microns.

In an example the metal mesh comprises at least one metal, such as one or more of copper and silver. In an example the metal is blackened on one or both sides; this can inhibit reflections from the metal, which can cause interference with the sensor(s).

In an example the line width is no greater than about 8.6 microns. About in this instance can be interpreted as a typical manufacturing tolerance, which may be +/−1 micron. In an example the line width is no greater than about 5 microns. In an example the metal traces are sufficiently narrow that they are not visible to an unaided human eye. In an example the metal mesh pattern is random. In an example the metal mesh pattern comprises a square or non-square shape, such as a hexagon shape or a parallelogram shape.

In an example the sheet resistance is less than about 15 ops. In an example the sheet resistance is less than about 5 ops. About in these instances can also mean +/−5%.

In an example the transparent flexible foil heater element exhibits a total haze of no more than about 5%, or a total haze of no more than about 2%, or a total haze of no more than about 1%. About in these instances can also mean +/−5%.

In an example the transparent flexible foil heater element exhibits a power density at 12V of at least about 500 W/m², or a power density of at least about 1000 W/m². In an example the transparent flexible foil heater element exhibits a power density at 24V of at least about 1000 W/m². About in these instances can also mean +/−5%.

In an example the transparent flexible foil heater element exhibits a visible light transmission, exclusive of the film, of at least about 90%, or at least about 95%, or at least about 97%. About in these instances can also mean +/−5%.

In an example the transparent flexible foil heater element exhibits a total transmission in the near infrared region of at least about 85%, or at least about 90%. About in these instances can also mean +/−5%.

In an example the transparent flexible foil heater element exhibits an attenuation of no more than about 0.5 dB at a radar frequency of about 77 GHz, or an attenuation of no more than about 0.1 dB at a radar frequency of about 77 GHz. About in these instances can also mean +1-5%.

In an example the transparent flexible foil heater element is configured to be formed into a 3D shape. In an example the transparent flexible foil heater element is configured to be used with an optical camera sensor. In an example the transparent flexible foil heater element is configured to be used with a light detection and ranging (LiDAR) sensor. In an example the transparent flexible foil heater element is configured to be used with a radar sensor. In an example the transparent flexible foil heater element is configured to be used with LED lighting systems. In an example the transparent flexible foil heater element is configured to be used with any combination of LED lighting systems, optical camera sensors, LiDAR sensors and radar sensors.

In some examples the transparent flexible foil heater element further includes a transparent conductive layer covering a surface of the metal mesh. In an example the transparent conductive layer covers the entirety of the top surface of the metal mesh and the entirety of the exposed surface of the film that defines the mesh open area. In an example the transparent conductive layer comprises carbon nanotubes (CNT). The CNT/CNT-containing material can be deposited on the metal mesh by either dry deposition methods or wet deposition (e.g., by printing or coating an ink that contains the CNT). Alternatively, Boron Nitride Nanotubes (BNNT) can be deposited on the metal mesh. These materials offer high thermal conductivity and low radar attenuation, and they are quite transparent in the visible light range (and possibly also in the NIR range). In still another alternative graphene inks can be used, which may offer similar attributes as CNT inks, but superior barrier film properties.

In an example the transparent flexible foil heater element is coupled to a lens. In an example the transparent flexible foil heater element is coupled to the lens by an optically-clear adhesive. In an example the transparent flexible foil heater element is coupled to a plastic lens via insert molding. Anti-reflective coatings can be applied to top and/or bottom surfaces of the lens assembly to further improve transmission in the visible and NIR wavelengths.

In some examples the transparent flexible foil heater element further includes spaced electrical busbars or other electrical contacts that are in electrical contact with the metal mesh so as to apply electrical power to the metal mesh. In an example busbars/electrical contacts are spaced apart by at least about 50 mm, or at least about 100 mm. About in these instances can also mean +/−5%.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1A is a top view and FIG. 1B is an exploded view of a transparent flexible foil heater element coupled to a lens.

FIG. 1C illustrates a metal mesh (MM) pattern for a transparent flexible foil heater element, and FIG. 1D is a partial closeup view thereof.

FIG. 2 is a graph of the power density vs. estimated deicing time through a 3 mm polycarbonate (PC) lens with 1 mm of ice on it.

FIG. 3 is a graph of power density vs. distance between heater busbars at 12V for four different transparent flexible foil heater elements.

FIG. 4 is a graph of power density vs. distance between heater busbars at 24V for three different transparent flexible foil heater elements.

FIG. 5 is a schematic cross-sectional view of one arrangement of a transparent flexible foil heater element coupled to a lens.

FIG. 6 is a schematic cross-sectional view of one arrangement of a transparent flexible foil heater element coupled to a lens.

FIG. 7 is a schematic cross-sectional view of one arrangement of a transparent flexible foil heater element optimized for insert molding to a lens.

FIG. 8 is a graph of total visual light transmittance (TVLT) of a transparent flexible foil heater element vs. wavelength from 400-1600 nm.

FIG. 9 is a graph of power density at 12V vs. busbar spacing of three different transparent flexible foil heater elements.

FIG. 10 is a graph of temperature vs. power density for a transparent flexible foil heater element.

### DETAILED DESCRIPTION

Examples of the devices, systems, methods and apparatuses discussed herein are not limited in application to the details of construction and the arrangement of components set forth in the following description or illustrated in the accompanying drawings. The devices, systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example. Unless otherwise stated herein, when “about” is used it means the stated value +/−5%.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

This disclosure involves the demonstration that translucent microwires at 0.4 mm width and 5 mm spacing can achieve high power density at 12V (>1,000 W/m² for typical radar lens geometries) and low radar attenuation (<0.5 dB) and high total visible light transmission (VLT) for the heater foil (TVLT ˜90%). However, the translucent microwires (with VLT 84%) are still visible enough to be an aesthetics concern. Thus, it is preferable to have a transparent heater foil solution without ‘visible’ microwires.

Note that the translucent microwires mentioned above (aka, AgeNT-1-G3) were made using metal mesh with thickness about 2 microns, line width about 5 microns and pitch about 100 microns. This resulted in sheet resistance of about 0.2 ops and VLT about 84%, thus a low VLT, non-uniform heating, and visible lines. Another version of metal mesh was also evaluated to create translucent microwires (aka, AgeNT-1-G2), using metal mesh with thickness about 2 microns, line width about 5 microns and pitch about 300 microns. This resulted in sheet resistance of about 1 ops and VLT about 95%. In the 100-micron pitch case, it was possible to fabricate microwires with width as small as 0.4 mm. This results in a microwire width being 4× the metal mesh pitch, which could be marginal for a heater application because there may be an insufficient number of metal traces making up each line, which could lead to non-uniform heating. Also, this could result in unacceptable radar attenuation. For best reliability, it is preferable to have the microwire width be at least 10× the metal mesh pitch; e.g., 3 mm for 300-micron pitch and 1 mm for 100-micron pitch. For the 300-micron pitch case, this results in a microwire width to metal mesh pitch ratio of only 1.3λ, which is not reliable at all as it does not provide enough connectivity for heater applications. Thus, it is preferable to have a robust transparent heater foil solution without visible microwires.

In order to address these limitations, it would be preferable to use a “flooded” heater design wherein the CNT ink fills in the gaps between the metal mesh traces, with the transparent conductive layer covering the entire heated lens surface (i.e., no visible microwires). However, this represents a considerable challenge for radar sensor applications. It is quite challenging for a flooded heater foil to provide rapid deicing and also low radar attenuation at the same time. The heater foil needs to have sufficiently low sheet resistance (preferably less than about 30 ohm/sq) to deliver high power density (greater than about 1,000 W/m²) for sufficiently rapid deicing (less than about 10 minutes) at traditional automotive voltage supply (12V) and also for a typical heater lens length for radar (about 100 mm). However, such low sheet resistance is expected to result in high radar attenuation (much higher than the <0.5 dB attenuation needed for ADAS). High radar attenuation is expected due to high reflection of the radar resulting from the low sheet resistance (i.e., the heater foil can behave more like an RF shield). This is exactly why the microwire heater foil solution was implemented for heating lenses used for radar sensors (i.e., to create apertures for radar transmission). It is important to note that there are no commercial examples of flooded heater foils with high power density at 12V and very low radar attenuation at 77 GHz. All of the traditional transparent conductive film offerings either do not provide sufficient power density at 12V and enable low radar attenuation at the same time. This list includes, but is not limited to, transparent conducting oxides (e.g., indium tin oxide or ITO), ultrathin metal films (e.g., atomic layer deposition or ALD films), conducting polymers (e.g., poly (3,4 ethylenedioxythiophene) or PEDOT), carbon nanomaterials (e.g., CNT, graphene), silver nanowires (AgNW) and metal meshes typically used for touch screens, heaters, and RF shielding.

This is what led us to conceive of a non-traditional metal mesh structure to create flooded heaters, with the following features:
Metal mesh is comprised of copper or potentially another metal such as silver, preferably but not necessarily blackened on at least one side (for lower reflectance, which can decrease the ADAS sensor signal to noise ratio)
Metal mesh is supported by clear plastic film
Mesh pitch greater than 3.9 mm (to create apertures for radar transmission within the metal mesh structure; radar operates at 77 Ghz (3.9 mm wavelength). A pitch of, e.g., 5.0 mm allows the 3.9 mm radar signal to easily pass through the 5 mm mesh openings
Mesh line width <8.6 microns (since the normal human eye has a resolution of 8.6 nm, this line width would make the metal mesh structure invisible to most people, or at least all but invisible to most people)
Mesh open area >95% (to also enable high transmission of visible and NIR wavelengths for LED lighting, optical camera sensors),
Mesh line thickness large enough to enable metal mesh sheet resistance less than about 30 ops

Specifically, in examples of the present invention we developed a metal mesh substrate fabricated with the following features:
Metal=copper, blackened on one side
Clear plastic film=100-micron thick PET
Pitch ˜5 mm
Line width ˜5 microns
Line thickness ˜2 microns
Open area >98%
Sheet resistance ˜11.7 ops

We made transparent heaters comprising this non-traditional metal mesh substrate plus CNT ink printed on top of the metal mesh plus printed silver busbars (aka, “AgeNT-12” where the “AgeNT” number as used in this document indicates the whole number sheet resistance of the heater foil). The AgeNT-12 (11.7 ohms/square or ops) has a low sheet resistance for a transparent conductive film (TCF) and provides the power density required for heating. The 5 mm pitch open mesh allows 77 Ghz radar to easily pass through the mesh thus the low attenuation. We demonstrated high power density at 12V (>1,000 W/m²) with very rapid and uniform heating via thermographic images. We also confirmed via calculations that the wide variety of heater geometries that are being considered for ADAS can be accommodated while still delivering high power density at 12V. We also confirmed very low radar attenuation at 77 GHz (<0.1 dB). We also confirmed high total visible light transmission (90.6%), low total haze (1.3%), high total NIR transmission at 905 nm (89.1%), and high total NIR transmission at 1,550 nm (91.0%).

Based on the above results we have demonstrated that it is possible to provide a “universal” ADAS heater that provides high power density at 12V (needed for radar, LiDAR and optical camera sensors), low radar attenuation at 77 GHz (needed for radar sensors), high visible light transmission (needed for optical cameras and LED lighting) and high NIR light transmission (needed for LiDAR sensors).

It is our understanding is that this universal ADAS heater also outperforms the current leading transparent heater solutions for lighting systems, radar, LiDAR, and optical camera sensors (e.g., CNT only solutions lack power density to operate at 12V, microwire solutions use visible wire in the range of 50 microns to 100 microns, visible to the human eye and thus detracting from the aesthetics, and other transparent conductive film heater solutions cannot meet the 0.5 dB radar attenuation standard).

The leading transparent heater solution for lighting systems (e.g., headlights) are opaque microwires. This solution provides adequate power density for rapid deicing (even at 12V) and reasonably high visible light transmission, but the microwires are clearly visible (which is highly undesirable for aesthetics). We have demonstrated that translucent microwires provide even faster deicing, with less visibility of the microwires. However, even though the translucent microwires are less visible, they still are visible enough to detract from aesthetics of the automobile. Thus, it would be preferable to have a transparent heater foil solution without visible microwires. AgeNT-12 delivers rapid deicing at 12V without visible microwires.

The leading transparent heater solution for optical cameras is peripheral heating (where there is an aperture for the camera to look through, so no direct heating in the lens area). There is a strong desire to avoid using microwires in the camera lens area to make it easier to interpret the camera images at high speed. AgeNT-12 delivers rapid deicing at 12V without visible microwires.

The leading transparent heater solution for LiDAR seems to be a CNT heater foil from Canatu, located in Vantaa, Tiilenlyojankuja 9, Finland. Their high sheet resistance heater foil (>30 ops) typically requires voltage to be higher than 12V to achieve high enough power density for rapid deicing. It is important to note that microwires are not used for LiDAR, as they make it too challenging to do rapid 3D imaging. AgeNT-12 delivers rapid deicing at 12V and enables even higher NIR light transmission and no microwires to interfere with LiDAR signal processing.

As previously mentioned, the leading transparent heater solution for radar sensors is microwire, which provides adequate power density for rapid deicing (even at 12V) and reasonably high visible light transmission, but the microwires are clearly visible (which is highly undesirable for aesthetics). AgeNT-12 delivers rapid deicing at 12V and ultra-low radar attenuation without visible microwires.

Heater foil structures were created in accordance with the following procedure.
Pick 457 mm×605 mm sheeted MM film with the desired mesh pattern
Remove coating side mask and discard
Pre-bake MM film for 3 min @140° C.
Screen-print CNT ink in a 431.8 mm×550.0 mm flooded rectangular pattern, where in one example the ink is a VC201 CNT Ink available from Chasm Advanced Materials, Canton, MA USA and has the following properties: Solids, (%) 2.46, Viscosity, (cP) (Brookfield, 5 rpm, Spindle LV4-#64) 2,500, Theoretical Wet-film Thickness, (μm) 27, Theoretical Dry-film Thickness, (nm) 665, Ink Consumption, (m1/m2) (Dependent on % coverage, @50% coverage) 13.5, Sheet Resistance, (Ω/□) >1 M, Visible Light Transmittance, (%) 99, and Haze, (%) 0.25
Bake sheets in a conveyorized oven 3 min @110° C.
Screen-print silver ink in a pattern to create the busbars. The bus bar pattern is determined by required heater power density, size of the heater, the available space for the bus bar, and the conductivity of the silver ink.
Bake sheets in a conveyorized oven for 5 min @120° C. with IR @20%
Laminate a protective mask over the coating side of the sheets, where the mask maintains the transparency of the TCF during handling and processing
Cut individual heaters using a digital knife cutter

A carbon ink can optionally be printed on top of the silver busbars. The carbon provides mechanical robustness and helps protect the silver busbars from oxidation.

The structure was tested for the following performance characteristics:
Heater performance
Visible light transmission and haze
NIR light transmission at 905 nm and 1,550 nm
Radar attenuation at 77 GHz
Adhesion

The following table provides data for several non-limiting examples of the disclosure. Other examples are described elsewhere, and performance illustrated in the drawings.

| | Heater element trade name - | | | |
|---|---|---|---|---|
| | AgeNT-1-G3 | AgeNT-1-G2 | AgeNT-3 | AgeNT-12 |
| Substrate | MM on 100 μm PET | MM on 100 μm PET | MM on 100 μm PET | MM on 100 μm PET |
| MM thickness (μm) | 2.0 | 2.0 | 2.0 | 2.0 |
| MM line width (μm) | 5.0 | 5.0 | 5.0 | 5.0 |
| MM pitch (mm) | 0.1 | 0.3 | 1.0 | 5.0 |
| Sheet Resistance | 0.2 | 1.0 | 2.6 | 11.7 |
| (ohm/sq) | | | | |
| VLT (%) | 84.4 | 95.0 | 97.1 | 97.9 |
| TVLT (%) | 78.1 | 88.0 | 89.9 | 90.6 |
| Haze (%) | 3.8 | 1.1 | 0.3 | 0.1 |
| THaze (%) | 5.0 | 2.3 | 1.5 | 1.3 |
| TT at 905 nm (%) | 73.8 | 85.8 | 88.0 | 89.1 |
| TT at 1550 nm (%) | 71.9 | 84.1 | 88.3 | 91.0 |
| Radar attenuation | 0.3 | NA¹ | 0.6 | 0.1 |
| at 77 Ghz (dB) | | | | |

(¹note that it is not practical to etch 0.5 mm bands in a MM with a 0.3 mm pitch so radar attenuation was not measured for this example)

The enclosed drawings and the descriptions below set forth exemplary metal mesh geometries, optoelectronic properties, attenuation, and exemplary designs and production of the transparent flexible foil heater element and heater using the element. Imaging results have illustrated the effect of the plastic (polycarbonate or PC) lens in spreading the heat, which facilitates faster and more uniform deicing.

An example of this disclosure is a transparent flexible foil heater element that has a clear plastic film with a surface, and a metal mesh on the surface of the film. The metal mesh comprises intersecting spaced metal traces. The inter-trace spacing can be regular, or not. The traces have a line width, a spacing between adjacent traces defines a mesh pitch, the mesh defines an open area within the mesh that exposes the film surface, and the mesh has a sheet resistance. In an example the line width is less than about 9 microns. In an example the mesh pitch is at least about 1 mm. In an example the open area is at least about 95%. In an example the sheet resistance is less than about 30 ops.

In an example the mesh pitch is at least about 3.9 mm. In an example the mesh pitch is at least about 5 mm. “About” in this instance can be interpreted as a typical manufacturing tolerance, which may be +/−1 mm.

In an example the clear plastic film comprises at least one of polyethylene terephthalate (PET), polycarbonate (PC) and cyclo-olefin polymer (COP). In an example the clear plastic film is about 100 microns thick. About can be interpreted as a typical manufacturing tolerance, which may be +/−5%. In this case that amounts to +/−5 microns.

In an example the metal mesh comprises at least one metal, such as one or more of copper and silver. In an example the metal is blackened on one or both sides.

In an example the line width is no greater than about 8.6 microns. About in this instance can be interpreted as a typical manufacturing tolerance, which may be +/−1 micron. In an example the line width is no greater than about 5 microns. In an example the metal traces are sufficiently narrow that they are not visible to an unaided human eye. In an example the metal mesh pattern is random. In an example the metal mesh pattern comprises a square or non-square shape, such as a hexagon shape or a parallelogram shape.

In an example the sheet resistance is less than about 15 ops. In an example the sheet resistance is less than about 5 ops. About in these instances can also mean +/−5%.

In an example the transparent flexible foil heater element exhibits a total haze of no more than about 5%, or a total haze of no more than about 2%, or a total haze of no more than about 1%.

In an example the transparent flexible foil heater element exhibits a power density at 12V of at least about 500 W/m², or a power density of at least about 1000 W/m². In an example the transparent flexible foil heater element exhibits a power density at 24V of at least about 1000 W/m². About in these instances can also mean +/−5%.

In an example the transparent flexible foil heater element exhibits a visible light transmission, exclusive of the film, of at least about 90%, or at least about 95%, or at least about 97%. About in these instances can also mean +/−5%.

In an example the transparent flexible foil heater element exhibits a total transmission in the near infrared region of at least about 85%, or at least about 90%. About in these instances can also mean +/−5%.

In an example the transparent flexible foil heater element exhibits an attenuation of no more than about 0.5 dB at a radar frequency of about 77 GHz, or an attenuation of no more than about 0.1 dB at a radar frequency of about 77 GHz. About in these instances can also mean +/−5%.

In an example the transparent flexible foil heater element is configured to be formed into a 3D shape. In an example the transparent flexible foil heater element is configured to be used with an optical camera sensor. In an example the transparent flexible foil heater element is configured to be used with a light detection and ranging (LiDAR) sensor. In an example the transparent flexible foil heater element is configured to be used with a radar sensor. In an example the transparent flexible foil heater element is configured to be used with LED lighting systems. In an example the transparent flexible foil heater element is configured to be used with any combination of LED lighting systems, optical camera sensors, LiDAR sensors and radar sensors.

In some examples the transparent flexible foil heater element further includes a transparent conductive layer covering a surface of the metal mesh. In an example the transparent conductive layer covers the entirety of the top surface of the metal mesh and the entirety of the exposed surface of the film that defines the mesh open area. In an example the transparent conductive layer comprises carbon nanotubes (CNT). The CNT/CNT-containing material can be deposited on the metal mesh by either dry deposition methods or wet deposition (e.g., by printing or coating an ink that contains the CNT). Alternatively, Boron Nitride Nanotubes (BNNT) can be deposited on the metal mesh. These materials offer high thermal conductivity and low radar attenuation, and they are quite transparent in the visible light range (and possibly also in the NIR range). In still another alternative graphene inks can be used, which may offer similar attributes as CNT inks, but superior barrier film properties.

In an example the transparent flexible foil heater element is coupled to a lens. In an example the transparent flexible foil heater element is coupled to the lens by an optically-clear adhesive. In an example the transparent flexible foil heater element is coupled to a plastic lens via insert molding. Anti-reflective coatings can be applied to top and/or bottom surfaces of the lens assembly to further improve transmission in the visible and NIR wavelengths.

In some examples the transparent flexible foil heater element further includes spaced electrical busbars or other electrical contacts that are in electrical contact with the metal mesh so as to apply electrical power to the metal mesh. In an example busbars/electrical contacts are spaced apart by at least about 50 mm, or at least about 100 mm.

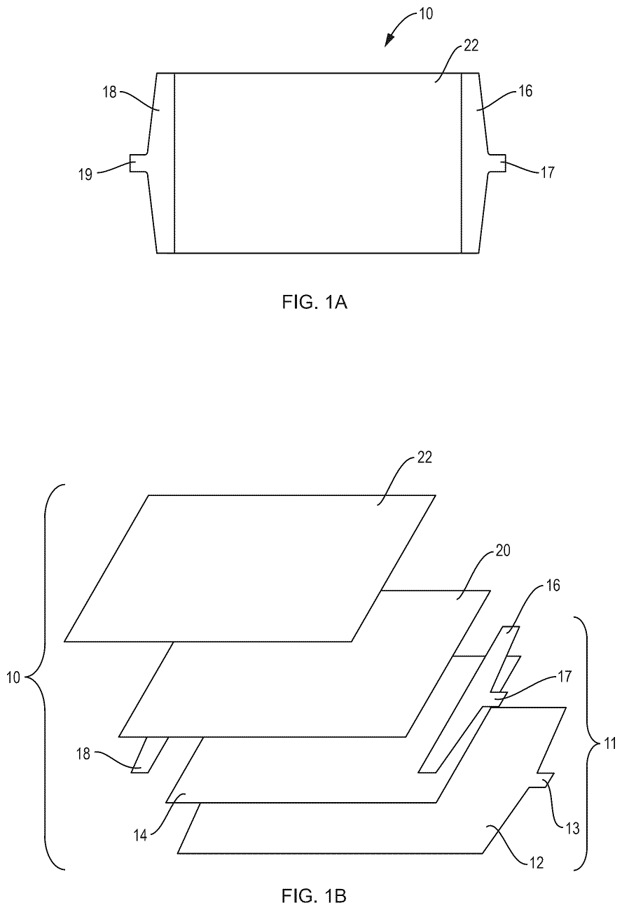

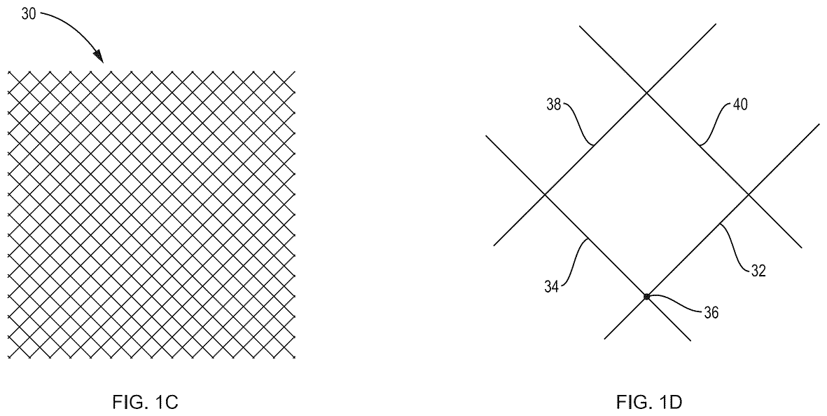

FIG. 1A is a top view and FIG. 1B is an exploded view of an assembly 10 including a transparent flexible foil heater element 11 coupled to a lens 22. Heater element 11 includes lower layer 12 comprising metal mesh (MM) on a clear substrate, which in this non-limiting example is a 100-micron PET sheet. More details on metal meshes are provided elsewhere. Protruding end regions of layer 12, such as region 13 that is visible in FIG. 1B, may optionally be included to provide an area to which electrical power can be coupled outside of the perimeter of lens 22. CNT layer 14 covers and encapsulates the MM of layer 12. CNT layer 14 can be printed from a VC201 ink. Busbars 16 and 18 may be created using a printed silver-containing paste (such as Loctite™ printable silver ink ECI 1010 from Henkel Corporation, Rocky Hill, CT, US). Busbars 16 and 18 provide points of electrical contact with the electrical power used to cause resistive heating of the MM and thus of heater element 11, to thereby heat lens 22 in order to clear the lens of moisture, snow, ice and the like. Busbars 16 and 18 may include end extension areas 17 and 19 that directly overlie the protruding end regions of the metal mesh. Optically clear adhesive (OCA) layer 20 (that may be a 50-micron OCA 8146-2 from the 3M Company) is used to couple heater element 11 to lens 22. Lens 22 may in one example be a 3 mm thick polycarbonate (PC) structure.

FIG. 1C illustrates a metal mesh (MM) pattern 30 for a transparent flexible foil heater element, and FIG. 1D is a partial closeup view thereof and comprising traces 32, 34, 38, and 40 that intersect (e.g., numbered intersection 36, FIG. 1D) at right angles and are regularly spaced, to form a square pattern. In this non-limiting example (termed AgeNT-15), the traces are 5 microns wide and 2 microns thick and are spaced at a 5 mm pitch. Generally, the AgeNT examples in the drawings have this 5-micron line width, 2-micron line height, and 5 mm pitch (line spacing). With a 100-micron PET sheet as the substrate, the total VLT without the substrate is 90.6%, the sheet resistance is 12 ops, and the metal areal coverage is 0.2%.

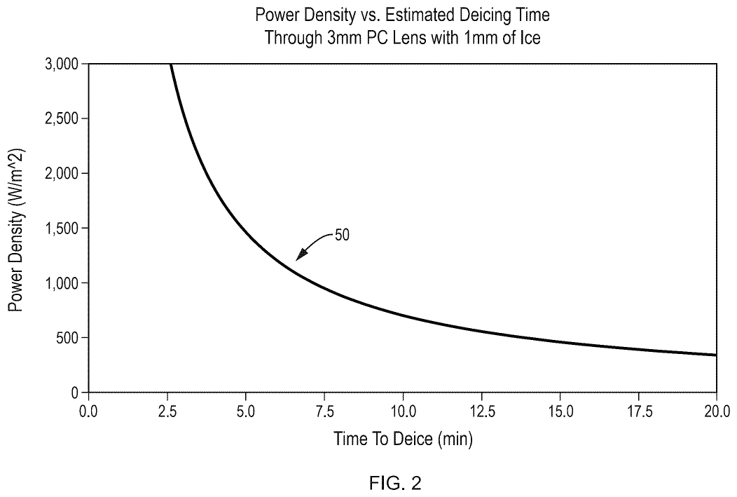

FIG. 2 is a graph of the required power density vs. estimated deicing time for a 3 mm polycarbonate (PC) lens (which is a typical ADAS lens configuration) with 1 mm of ice on it. The vehicle industry generally desires a de-icing time of no more than 10 minutes, and in some cases no more than 5 minutes. FIG. 2 establishes that the minimum power density should be 700 W/m2, and preferably at least 1,500 W/m2. The transparent flexible foil heaters of the present disclosure can meet these requirements, while still providing transparency to visible light, NIR, and radar frequencies.

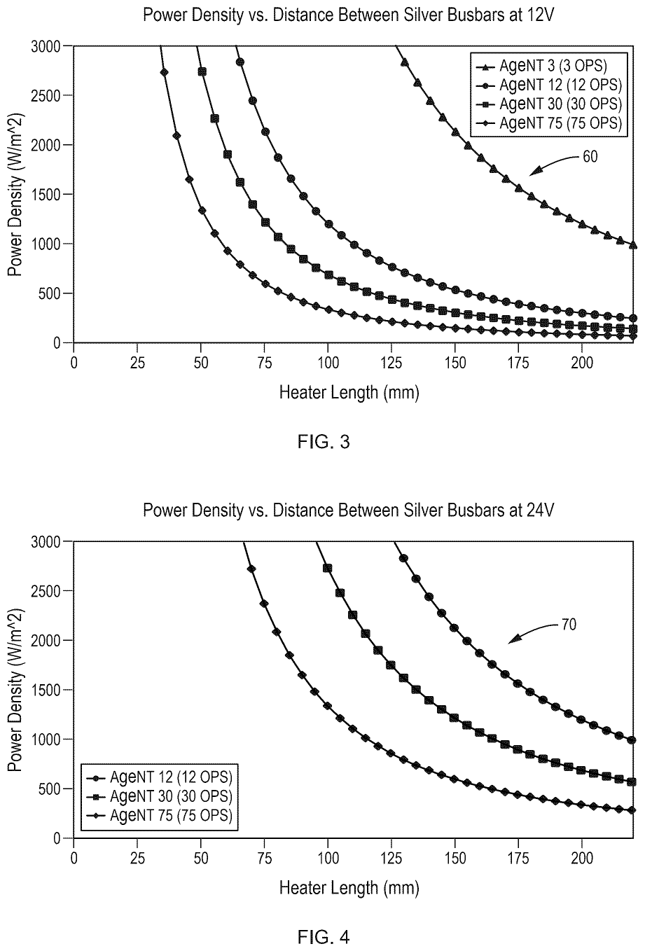

FIG. 3 is a graph of power density vs. distance between heater busbars at 12V for four different transparent flexible foil heater elements, with sheet resistances of 3 ops, 12 ops, 30 ops, and 75 ops. FIG. 4 is a graph of power density vs. distance between heater busbars at 24V for three different transparent flexible foil heater elements, namely the 12 ops, 30 ops, and 75 ops examples. Given the typical ADAS sensor lens sizes, the distance between the busbars is more than 60 mm. At 12V the sheet resistance of the heater foil needs to be no more than 30 ops to deliver a power density between 700 and 1,500 W/m2. At 24V the heater foil can tolerate a higher sheet resistance of perhaps 60 ops or more to deliver this power density.

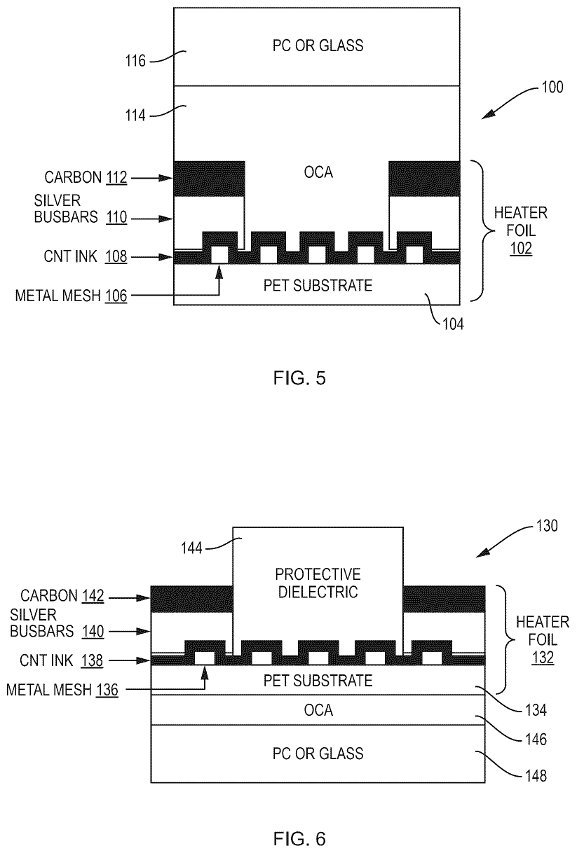

FIG. 5 is a schematic cross-sectional view of one arrangement of an assembly 100 of a transparent flexible foil heater element 102 coupled to a lens 116 with OCA 114. Lens 116 is typically but not necessarily made from PC or glass. Heater element 102 includes copper MM 106 on PET substrate 104. CNT ink 108 covers and encapsulates MM 106, including the metal traces and the open spaces between them—thus the top surface of substrate 104 between the traces of the MM. Silver busbars 110 are on top of parts of CNT ink 108. Optional carbon layer 112 can cover the busbars, to help protect the silver of the busbars from damage. OCA 114 (which can be a film or a liquid) encapsulates heater foil 102, protecting it from physical damage.

FIG. 6 is a schematic cross-sectional view of one arrangement of an assembly 130 of a transparent flexible foil heater element 132 that is backside laminated to or coupled to a lens 148 with OCA 146. Lens 148 is typically but not necessarily made from PC or glass. Heater element 132 includes copper MM 136 on PET substrate 134. CNT ink 138 covers and encapsulates MM 136, including the metal traces and the open spaces between them—thus the top surface of substrate 134 between the traces of the MM. Silver busbars 140 are on top of parts of CNT ink 138. Optional carbon layer 142 can cover the busbars, to help protect the silver of the busbars from damage. The CNT/MM is left open—not encapsulated with the OCA as in FIG. 5. A protective dielectric 144 can be printed over CNT ink 138.

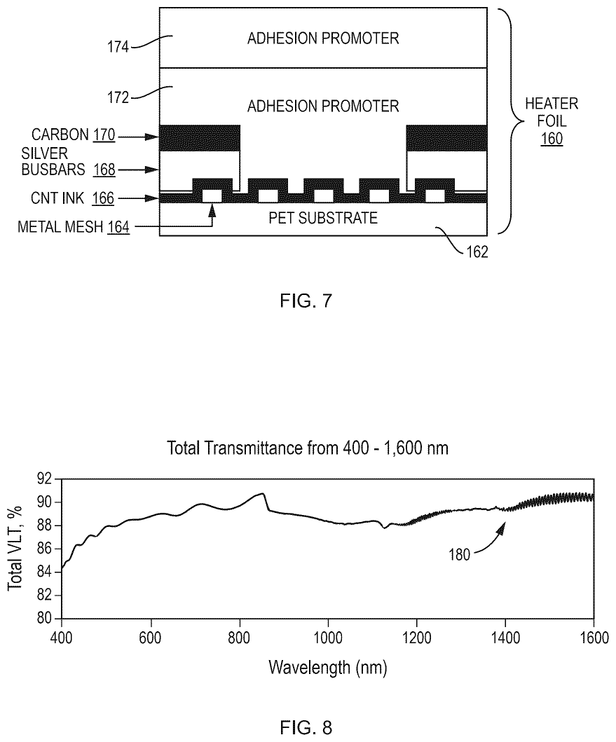

FIG. 7 is a schematic cross-sectional view of one arrangement of a transparent flexible foil heater element or foil 160 optimized for insert molding to a lens (not shown) using one or more adhesion promoters 172 and 174. In this example the plastic lens would be molded against layer 174. Foil 160 includes copper MM 164 on PET substrate 162. CNT ink 166 covers and encapsulates MM 164, including the metal traces and the open spaces between them—thus the top surface of substrate 162 between the traces of the MM. Silver busbars 168 are on top of parts of CNT ink 166. Optional carbon layer 170 can cover the busbars, to help protect the silver of the busbars from damage. Adhesion promoter layer 172 encapsulates CNT layer 166 and carbon layer 170, protecting them from physical damage. In another example (not shown) the adhesion promoter layer(s) can be left out by using a two-shot injection molding process which fully encapsulates the heater foil (without adhesion promoters) in the PC resin of the lens.

FIG. 8 is a graph of total visual light transmittance (TVLT) of a transparent flexible foil heater element vs. wavelength from 400-1600 nm. This example illustrates measurements made of the AgeNT-12 flooded heater foil detailed in the Table above. The total VLT varies from about 85% to about 91%.

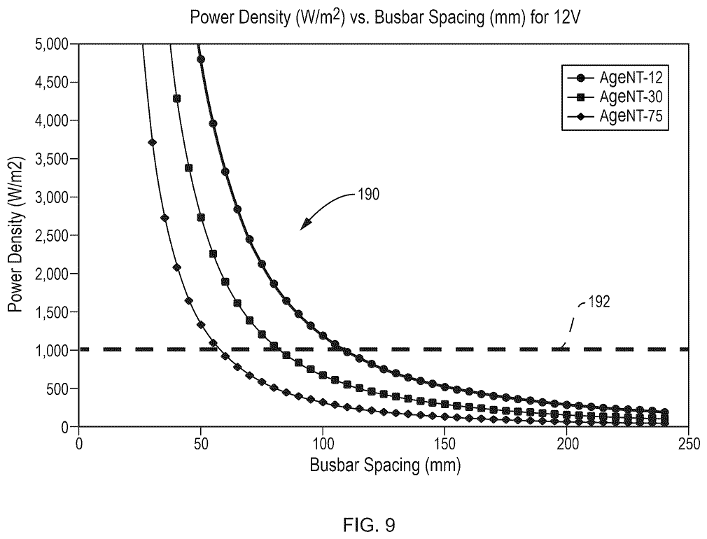

FIG. 9 is a graph of power density at 12V vs. busbar spacing of three different AgeNT transparent flexible foil heater elements, with sheet resistance (in ops) of 12, 30 and 75. The horizontal line indicates the busbar spacing needed to achieve a 1,000 W/m2 power density. The higher the sheet resistance the closer the busbars need to be to achieve a given power density. This curve can help to predict the construction and layout of a foil heater that can achieve the necessary ADS sensor lens clearing.

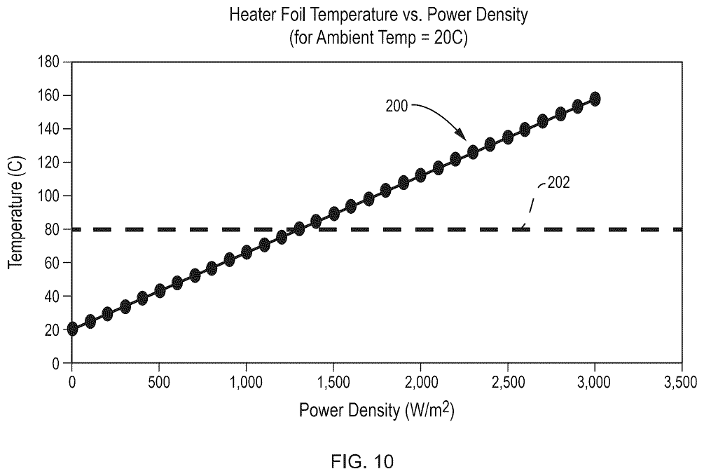

FIG. 10 is a graph of heater foil temperature vs. power density (at ambient temperature of 20° C.) for a transparent flexible foil heater element of this disclosure. The horizontal line at 80° C. shows that a power density of about 1,300 W/m2 is needed to maintain the desired heater foil temperature.

Another example involves printing a CNT ink formulation prepared by mixing a CNT/IPA (isopropyl alcohol) paste into a clear dielectric ink. This CNT ink formulation may be superior and have better optical properties than a traditional CNT ink in optical and etch resist properties. Adding a dielectric ink may increase the optical and etch resistance properties of a CNT ink.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A transparent flexible foil heater element, comprising:
a clear plastic film with a surface;
a metal mesh on the surface of the film, the metal mesh comprising intersecting spaced metal traces that have a line width, wherein a spacing between adjacent traces defines a mesh pitch, the mesh defines an open area within the mesh that exposes the film surface, and the mesh has a sheet resistance;
wherein the line width is less than 9 microns;
wherein the mesh pitch is at least 1 mm;
wherein the open area is at least 95%; and
wherein the sheet resistance is less than 30 ohms per square (ops).

2. The transparent flexible foil heater element of claim 1, wherein the mesh pitch is at least 3.9 mm.

3. The transparent flexible foil heater element of claim 1, wherein the mesh pitch is at least 5 mm.

4. The transparent flexible foil heater element of claim 1, wherein the clear plastic film comprises at least one of polyethylene terephthalate (PET), polycarbonate (PC) and cyclo-olefin polymer (COP).

5. The transparent flexible foil heater element of claim 1, wherein the clear plastic film is about 100 microns thick.

6. The transparent flexible foil heater element of claim 1, wherein the metal mesh comprises at least one of copper and silver.

7. The transparent flexible foil heater element of claim 1, wherein the metal traces are blackened on one or both sides.

8. The transparent flexible foil heater element of claim 1, wherein the line width is no greater than 8.6 microns.

9. The transparent flexible foil heater element of claim 1, wherein the line width is no greater than 5 microns.

10. The transparent flexible foil heater element of claim 1, wherein the metal traces are sufficiently narrow that they are not visible to an unaided human eye.

11. The transparent flexible foil heater element of claim 1, wherein the metal mesh pattern is random.

12. The transparent flexible foil heater element of claim 1, wherein the metal mesh pattern comprises a square shape, a hexagon shape, or a parallelogram shape.

13. The transparent flexible foil heater element of claim 1, exhibiting a total haze of no more than 5%.

14. The transparent flexible foil heater element of claim 1, exhibiting a power density of at least 500 W/m² at 12V.

15. The transparent flexible foil heater element of claim 1, exhibiting a power density of at least 1,000 W/m² at either 12V or 24V.

16. The transparent flexible foil heater element of claim 1, exhibiting a visible light transmission, exclusive of the film, of at least 90%.

17. The transparent flexible foil heater element of claim 1, exhibiting a total transmission in the near infrared region of at least 85%.

18. The transparent flexible foil heater element of claim 1, exhibiting an attenuation of no more than 0.5 dB at a radar frequency of about 77 GHz.

19. The transparent flexible foil heater element of claim 1, configured into a 3D shape.

20. The transparent flexible foil heater element of claim 1, configured to be used with any combination of optical camera sensors, LiDAR sensors, radar sensors and LED lighting systems.

21. The transparent flexible foil heater element of claim 1, further comprising a transparent layer covering a surface of the metal mesh and comprising carbon nanotubes (CNT).

22. The transparent flexible foil heater element of claim 1, further comprising spaced electrical busbars that are in electrical contact with the metal mesh.

23. The transparent flexible foil heater element of claim 22, wherein the busbars are spaced apart by at least 50 mm.

24. A lens assembly that is constructed and arranged to be heated by electrical power supplied to the lens assembly, wherein the lens assembly is configured to be used with at least one ADAS sensor selected from the group of sensors consisting of an optical camera sensor, a light detection and ranging (LiDAR) sensor, and a radar sensor, the lens assembly comprising:
a lens that is configured to transmit electromagnetic radiation at least at a wavelength that can be sensed by the sensor; and
a heater element coupled to the lens and comprising:
a clear plastic film with a surface;
a metal mesh on the surface of the film, the metal mesh comprising intersecting spaced metal traces that have a line width, wherein a spacing between adjacent traces defines a mesh pitch, the mesh defines an open area within the mesh that exposes the film surface, and the mesh has a sheet resistance;
wherein the line width is less than 9 microns;
wherein the mesh pitch is at least 1 mm;
wherein the open area is at least 95%;
wherein the sheet resistance is no more than 30 ohms per square; and
spaced electrical busbars that are in electrical contact with the metal mesh and are configured to supply electrical power to the mesh, to cause resistive heating of the mesh and thereby heat the lens.
